(19) United States
(12) Patent Application Publication
(10) Pub. No.: US 2013/0015949 A1
(43) Pub. Date: Jan. 17, 2013

(54) PAYMENT CARD WITH USER VALIDATION FUNCTION

(71) Applicants: YING-CHUAN YU, Tu-Cheng (TW); YING-XIONG HUANG, Tu-Cheng (TW)

(72) Inventors: YING-CHUAN YU, Tu-Cheng (TW); YING-XIONG HUANG, Tu-Cheng (TW)

(73) Assignee: HON HAI PRECISION INDUSTRY CO., LTD., Tu-Cheng (TW)

(21) Appl. No.: 13/323,828

(22) Filed: Dec. 13, 2011

(30) Foreign Application Priority Data
Jul. 15, 2011 (TW) 100125102

(51) Int. Cl. G06F 7/04

(52) U.S. Cl. 340/5.53

(57) ABSTRACT

A payment card includes a processor, a display, and a fingerprint capturing unit to capture a fingerprint of a user. A storage unit is used to store one or more reference fingerprints. The processor compares the fingerprint captured by the fingerprint capturing unit with the one or more reference fingerprints, and controls the display to display predetermined information when the fingerprint captured by the fingerprint capturing unit matches one of the one or more reference fingerprints.

### BACKGROUND

1. Technical Field

The present disclosure relates to payment cards, and particularly to a payment card having user validation function.

2. Description of Related Art

A payment card such as a credit card can be used to make an online payment. Information such as a card number and a confirmation code will usually need to be input. It is desirable and useful that the card number and the confirmation code are only accessible to valid users.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic block diagram of a payment card in accordance with an embodiment.

FIG. 2 is an exemplary flow chart implemented by the payment card of FIG. 1.

### DETAILED DESCRIPTION

Embodiments of the present disclosure will now be described in detail with reference to the accompanying drawings.

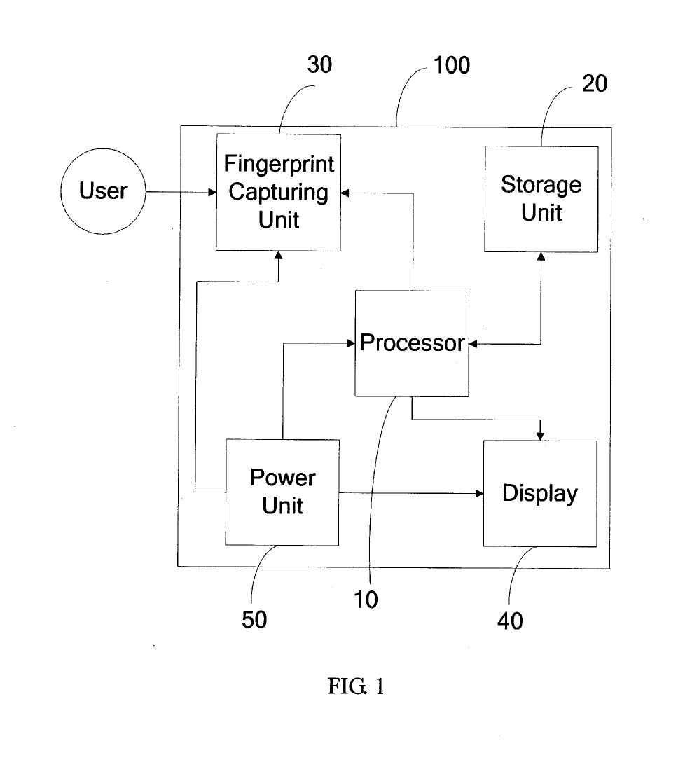

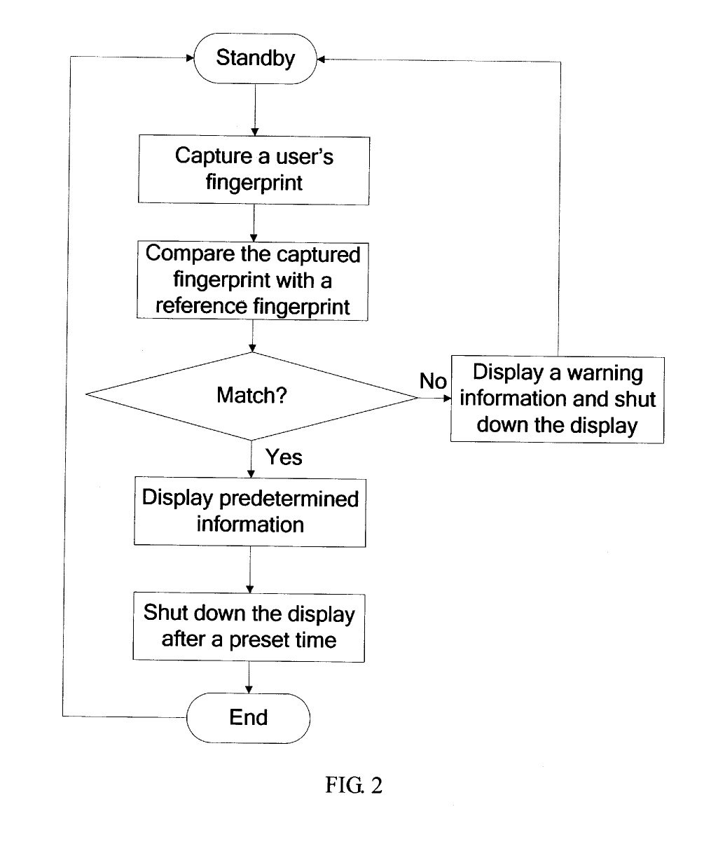

Referring to FIGS. 1 and 2, a payment card 100 can be used in financial transactions. When making an online payment, a card number and a confirmation code associated with the payment card 100 need to be input. The payment card 100 includes a processor 10, a storage unit 20, a fingerprint capturing unit 30, a display 40, and a power unit 50. The power unit 50 is a solar panel that can receive and convert solar energy to electrical power to power the electronic components of the payment card 100.

The fingerprint capturing unit 30 is used to capture an image of a fingerprint of a user. In the embodiment, the fingerprint capturing unit 30 can be an optical fingerprint sensor, a capacitance fingerprint sensor, etc. The storage unit 20 stores one or more reference fingerprints. When a fingerprint is captured by the fingerprint capturing unit 30, the processor 10 compares the captured fingerprint with the one or more reference fingerprints, and controls the display 40 to display the card number and the confirmation code if the captured fingerprint matches the one or more reference fingerprints. Otherwise, the processor 10 controls the display 40 to display warning message to indicate an invalid attempt to use the card 100. After the card number, the confirmation code, or the warning message has been displayed for a preset time, the processor 10 shuts down the display 40. In the embodiment, the display 10 is a reflection type display, such as an electrophoretic display.

In an exemplary embodiment, the storage unit 20 stores a number of reference fingerprints. When the fingerprint capturing unit 30 captures a number of fingerprints, the processor 10 records the sequence of the capturing of the fingerprints. The processor 10 compares the captured fingerprints, and executes a preset operation corresponding to the sequence of the capturing of the fingerprints when the captured fingerprints match the reference fingerprints.

For example, the storage unit 20 stores two reference fingerprints. When the fingerprint capturing unit 30 captures a first fingerprint and a second fingerprint, the processor 10 records the sequence of the capturing of the first and second fingerprints. If the first and second fingerprints respectively match the two reference fingerprints and are captured in a first sequence, such as forefinger then middle finger, the processor 10 controls the display 40 to display the card number and the confirmation code. If the first and second fingerprints respectively match the two reference fingerprints and are captured in a second sequence, such as middle finger then forefinger, the processor 10 shuts down the display 40.

While various embodiments have been described and illustrated, the disclosure is not to be construed as being limited thereto. Various modifications can be made to the embodiments by those skilled in the art without departing from the true spirit and scope of the invention as defined by the appended claims.

What is claimed is:

1. A payment card comprising:
a processor;
a display;
a fingerprint capturing unit to capture a fingerprint of a user; and
a storage unit configured to store one or more reference fingerprints;
wherein the processor compares the fingerprint captured by the fingerprint capturing unit with the one or more reference fingerprints, and controls the display to display predetermined information when the fingerprint captured by the fingerprint capturing unit matches one of the one or more reference fingerprints.

2. The payment card according to claim 1, wherein when the storage unit stores a plurality of reference fingerprints, and the fingerprint capturing unit captures a plurality of fingerprints of a user, the processor records a sequence of the capturing of the plurality of fingerprints, and executes a predetermined operation when all of the plurality of fingerprints match the reference fingerprints.

3. The payment card according to claim 1, wherein the one or more reference fingerprints comprise a first reference fingerprint and a second reference fingerprint, when the display displays the predetermined information, after having determined that a first fingerprint and a second fingerprint captured by the fingerprint capturing unit respectively match the first reference fingerprint and the second fingerprint, the processor shuts down the display if a sequence of the capturing of the first fingerprint and the second fingerprint matches a preset sequence.

4. The payment card according to claim 1, wherein the display is a reflection type display.

5. The payment card according to claim 4, wherein the display is an electrophoretic display.

6. The payment card according to claim 1, further comprising a solar panel configured to receive and convert solar energy into electrical power.

7. The payment card according to claim 1, wherein after the predetermined information has been displayed for a preset time, the processor shuts down the display.
